(19) United States
(12) Patent Application Publication
(10) Pub. No.: US 2003/0074663 A1
(43) Pub. Date: Apr. 17, 2003

(54) Apparatus and method for operating an electronic program guide

(76) Inventor: Young-hwan Pan, Suwon-si (KR)

Correspondence Address: Joseph J. Buczynski, Roylance, Abrams, Berdo & Goodman, L.L.P., Suite 600, 1300 19th Street, N.W., Washington, DC, 20036, US

(21) Appl. No.: 10/225,421

(22) Filed: Aug. 22, 2002

(30) Foreign Application Priority Data
Oct. 15, 2001 (KR) 2001-63376

(51) Int. Cl. G06F 3/00; H04N 5/445; G06F 13/00

(52) U.S. Cl. 725/39; 725/52; 725/61

(57) ABSTRACT

An apparatus and method for operating an EPG is provided, using a displayed control panel that does not hide program cells including programming information. The apparatus and method for operating an EPG perform the operations of displaying a control panel which controls time information on a display screen that displays an electronic program guide, selecting the time information by highlighting a predetermined button on the displayed control panel, and selecting a channel from among a plurality of channels by highlighting another predetermined button to view programming information for that channel in accordance with the selected. Accordingly, viewers can search for TV programs more conveniently, making time and channel movements more quickly and precisely using a control panel that does not hide program cells that include programming information.

This application claims benefit under 35 U.S.C. § 119 from Korean Patent Application No. 2001-63376, filed on Oct. 15, 2001, the entire content of which is incorporated herein by reference.

### BACKGROUND OF THE INVENTION

1. Field of the Invention

The present invention relates to an apparatus and method for operating an on-screen electronic program guide (EPG) of a television receiver. More particularly, the present invention relates to an apparatus and method for an operating an EPG which allows for easy scanning of programming time and channel information through the use of a control panel displayed on the display screen of the television receiver along with the EPG, without unnecessarily hiding program cells of the EPG which contain programming information.

2. Description of the Related Art

Recently, broadcasting stations have begun to provide EPGs to allow TV viewers to find program guides on the television screen, instead of in newspapers or other printed program guides. An EPG is a common feature of digital broadcasting. In digital broadcasting, an image stream and a sound stream are compressed into digital information, along with system information and program information compressed in accordance with the PSIP (Program and System Information Protocol) standards.

A television receiver capable of receiving digital broadcasts decodes the program-related information from data provided with the image information and sound information, and displays an EPG based on that information on the television receiver screen. Typically, a user can access such program information for a maximum of 16 days in advance according to the PSIP standards. In the EPG, the program information is typically listed in a table organized by channel and time.

In general, the EPG shows channels on the vertical axis and time on the horizontal axis, to provide the user with any combination of data and channel. If a control device, such as a remote control device, includes four directional keys (up, down, left, right), the user can manipulate those keys to highlight, for example, a channel of interest in a displayed program cell. For example, the user can scan the EPG one channel at a time using the up and down keys, and can move by a page at a time using the channel key. When the user wants to move hundreds of channels at a time, the user enters the channel number directly. However, in a conventional method, when the user moves on the time axis, there is no choice but to move by 30 minutes at a time using the directional keys. As stated above, it is common for a television receiver to store programming information up to 16 days in advance due to the increase of memory in the television receiver. Hence, if the user wants to obtain EPG information ten days in advance, it is necessary for the user to manipulate the control keys on the control device to scroll through the EPG in 30 minute intervals, which is a very time-consuming and complicated process. Also, these program guides hide the program cells when the user controls the display screen to display a virtual control panel.

### SUMMARY OF THE INVENTION

It is an object of the present invention to provide an apparatus and method for operating an electronic program guide (EPG), which allows easy scanning of programming time and channel information through the use of a displayed control panel which does not hide program cells that include EPG information.

To substantially accomplish this and other objects, the present invention provides an apparatus and method for operating an EPG. The apparatus and method perform the operations of displaying a control panel which controls time information on an electronic program guide screen, selecting time information by operating a predetermined button on the displayed control panel, and operating another predetermined button to select a channel from among a plurality of channels for viewing programming information for that channel in accordance with the selected time information.

Preferably, the time information is selected by highlighting the predetermined button and the channel is selected by highlighting the other predetermined button. Also, the highlighted time information and the highlighted channel are displayed at the same time on the screen which displays the control panel and the electronic program guide, and the time information and the channel programming information are selected and scanned using different buttons. A time interval below a reference value, a time interval above the reference value, a date, and a current time may be selected using the displayed control panel. The display of the control panel may be turned on and off by controlling a predetermined key or keys.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram illustrating an example of components of a device for operating an EPG;

FIGS. 2 through 4 are views illustrating examples of a display device for describing a method for operating an EPG according to an embodiment of the present invention.

### DETAILED DESCRIPTION OF THE PREFERRED EMBODIMENT

An embodiment of the present invention will now be described with reference to the accompanying drawings.

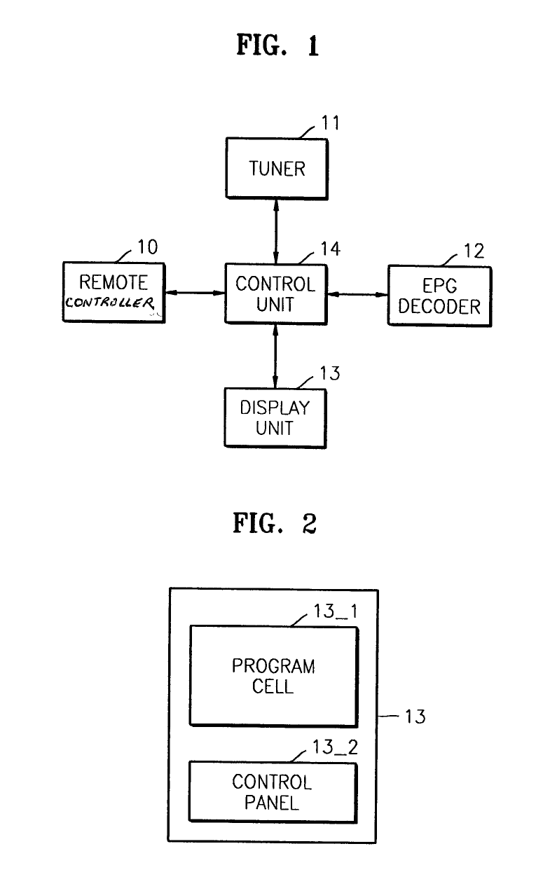

FIG. 1 is a block diagram illustrating an example of components of a device, such as a television receiver, for displaying and operating an EPG. The device includes a remote controller 10 for inputting information, a tuner 11 for tuning a signal received through an antenna (not shown), and an EPG decoder 12 which separates the signals tuned by the tuner 11 into an audio/video signal and additional information data and decodes those signals. The device further includes a display unit 13 which displays the signals decoded by the EPG decoder 12, and a controller 14 which controls the tuner 11 and the EPG decoder 12 according to the signals provided by the remote controller 10 by outputting a control signal indicating the desired data to be output from the EPG decoder 12. The tuner 11 and EPG decoder 12 operate in accordance with this control signal to enable the EPG decoder 12 to output the desired data as discussed below.

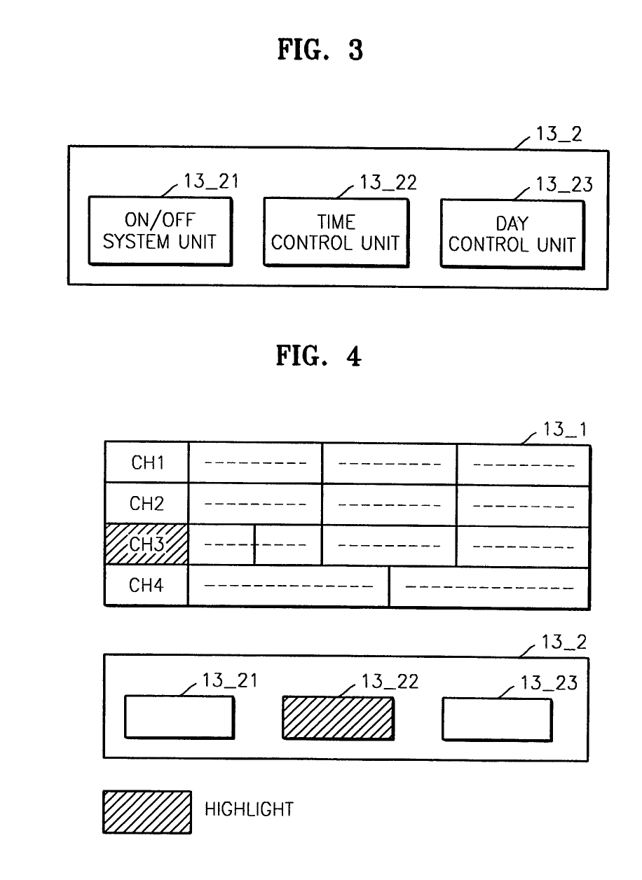

FIG. 2 is a view illustrating the display unit 13 displaying a program cell 13_1 that includes EPG information and a control panel 13_2. FIG. 3 is a detailed view of an example of the control panel 13_2, and FIG. 4 is a view illustrating an example of how a user can scan programming time and channel information through the use of different keys on one display.

Referring to FIGS. 1 through 4, an embodiment of the present invention will be described in detail. The user uses the remote controller 10 to select a program from among programs which are provided by a broadcasting station or an external provider, by manipulating one or more keys on the remote controller 10 to cause the remote controller 10 to output a signal corresponding to the selected program. The controller 14 receives the signal provided by the remote controller 10, and outputs a control signal for tuning to the program provided by broadcasting stations or external program providers according to the signal provided by the remote controller 10. The tuner 11 then tunes to the signals of the broadcasting stations or the external program providers from among the signals received through the antenna (not shown) according to the control signal from the controller 14, and outputs those tuned signals to the EPG decoder 12.

The EPG decoder 12 separates the signals which are tuned by the tuner 11 into an audio/video signal and additional information data, and decodes and outputs those signals. The display unit 13 displays the EPG signal decoded by the EPG decoder 12 in the program cell 13_1 as shown in FIG. 2. If the user inputs the on/off key of the control panel through the remote controller 10 (see FIG. 1), the display unit 13 displays the control panel 13_2 along with the program cell 13_1 as shown in FIG. 2.

The program cell 13_1 displays the EPG information according to programming channel and time, and a user can scan the programming for different channels and times by using, for example, the up and down keys of the remote controller 10 or appropriate keys on the television receiver. The control panel 13_2 is displayed to enable the user to change the time information without having to scroll through the displayed EPG information. The control panel 13_2 further includes an on/off operator 13_21, a time controller 13_22 and a day controller 13_23. The user can operate the control panel 13_2 by using, for example, the left and right keys of the remote controller 10, or the appropriate keys on the television receiver. The user can use the remote controller 10, for example, or the appropriate keys on the television receiver, to control the on/off operator 13_21 to display or clear the control panel 13_2 on the display unit 13 as desired. The time controller 13_22 allows the user to select the size of the time intervals that will be used to scroll through the EPG information displayed in the program cell 13_1. For example, the time controller 13_22 can be set by the user to enable a user to view EPG information for the current time. The time controller 13_22 can further be set by the user to enable the user to scroll through the EPG information at short time intervals (e.g., 30 minute intervals) or long time intervals (e.g., 3 or 6 hour intervals). The reference time used by the time controller 13_22 is set by the user, and a time interval below the reference time is considered a short time interval, while a time above the reference time is considered a long time interval. The day controller 13_23 functions as a date controller, which enables a user to select a date for searching EPG information displayed in the program cell 13_1. If the user selects a particular date using the day controller 13_23, the user can view the EPG information displayed in the program cell 13_1 for that selected date.

As can be appreciated from the above, the program cell 13_1 and the control panel 13_2 can be operated by using, for example, the up and down keys and the left and right keys of the remote controller (or other appropriate keys on the remote controller or on the television receiver itself) at the same time. Referring to FIG. 4, in this example, the time and the day are controlled by highlighting the left and right keys and the channel is controlled by highlighting the up and down keys.

It is noted that the scope of the present invention is not limited to the preferred embodiment described above, and it is apparent that variations and modifications by those skilled in the art can be affected with the spirit and scope of the present invention. As described above, viewers can search for TV programs more conveniently, making time and channel movements more quickly and precisely, using a control panel that does not hide program cells.

What is claimed is:

1. A method for operating an EPG, comprising:
displaying a control panel which controls time information on a display screen adapted to display an electronic program guide;
selecting the time information by operating a predetermined button on the displayed control panel; and
operating another predetermined button to select a channel from among a plurality of channels for viewing programming information for that channel in accordance with the selected time information.

2. The method of claim 1, wherein the selected time information and the selected channel are displayed at the same time on the display screen which displays the control panel and the electronic program guide.

3. The method of claim 1, wherein the selecting step sets the time information as one of the following: a time interval below a reference value, a time interval above the reference value, a date, and a current time.

4. The method of claim 1, further comprising the step of operating a displayed button to turn the control panel on and off.

5. The method of claim 1, wherein the selecting step is performed by highlighting the predetermined button on the display screen, and the operating step is performed by highlighting the other predetermined button on the display screen.

6. The method of claim 1, wherein the operating step includes scrolling through displayed programming information for the selected channel at time intervals indicated by the selected time information.

7. An apparatus for operating an EPG, comprising:
a display, adapted to display a control panel which controls time information and an electronic program guide; and
a controller, adapted to enable a user to operate a predetermined button on the displayed control panel to select the time information, and to enable the user to operate another predetermined button to select a channel from among a plurality of channels for viewing programming information for that channel in accordance with the selected time information.

8. The apparatus of claim 7, wherein the display is adapted to display the selected time information and the selected channel concurrently.

9. The apparatus of claim 7, wherein the time information is set as one of the following: a time interval below a reference value, a time interval above the reference value, a date, and a current time.

10. The apparatus of claim 7, wherein the controller is further adapted to enable the user to operate a further button displayed on the display to turn the control panel on and off.

11. The apparatus of claim 7, wherein the controller is further adapted to highlight the predetermined button on the display screen when the predetermined button is selected, and to highlight the other predetermined button on the display to when the other predetermined button is selected.

12. The apparatus of claim 7, wherein the controller is further adapted to enable the user to scroll through displayed programming information for the selected channel at time intervals indicated by the selected time information.

13. A computer-readable medium of instructions for controlling a device to operate an EPG, comprising:
a first set of instructions, adapted to control a display of the device to display a control panel which controls time information and an electronic program guide;
a second set of instructions, adapted to control the device to select the time information in response to operation of a predetermined button on the displayed control panel; and
a third set of instructions, adapted to control the device to select a channel from among a plurality of channels for viewing programming information for that channel in accordance with the selected time information in response to operation of another predetermined button.

14. The computer-readable medium of instructions of claim 13, wherein the selected time information and the selected channel are displayed at the same time on the screen which displays the control panel and the electronic program guide.

15. The computer-readable medium of instructions of claim 13, wherein the second set of instructions is adapted to control the device to set the time information as one of the following: a time interval below a reference value, a time interval above the reference value, a date, and a current time.

16. The computer-readable medium of instructions of claim 13, further comprising a fourth set of instructions, adapted to control the display to display a button which can be operated to turn the control panel on and off.

17. The computer-readable medium of instructions of claim 13, wherein the second set of instructions is further adapted to control the display to highlight the predetermined button on the display screen when the predetermined button is operated, and the third set of instructions is further adapted to control the display to highlight the other predetermined button on the display screen when the other predetermined button is operated.

18. The computer-readable medium of instructions of claim 13, wherein the third set of instruction is further adapted to control the device to enable the user to scroll through displayed programming information for the selected channel at time intervals indicated by the selected time information.
